(19) United States
(12) Patent Application Publication
(10) Pub. No.: US 2002/0053300 A1
(43) Pub. Date: May 9, 2002

(54) Water resistant building materials

(76) Inventor: Thomas W. Beckenhauer, Puyallup, WA (US)

Correspondence Address: SEED INTELLECTUAL PROPERTY LAW GROUP PLLC, 701 FIFTH AVE, SUITE 6300, SEATTLE, WA, 98104-7092, US

(21) Appl. No.: 10/043,602

(22) Filed: Jan. 9, 2002

Related U.S. Application Data
(63) Continuation of application No. 09/669,100, filed on Sep. 25, 2000.

(51) Int. Cl. B05D 3/02; C04B 7/02; C04B 24/08; C04B 24/00; C09K 3/18

(52) U.S. Cl. 106/2; 427/376.1; 106/666; 106/724

(57) ABSTRACT

Methods and compositions useful for increasing water resistance of a surface associated with a concrete, masonry or wood building material as disclosed herein. The method comprises the steps of applying a selected amount of an aqueous treating solution to the surface, wherein the aqueous treating solution includes a hydrophobic anion salt dissolved in water; allowing a portion of the aqueous treating solution to absorb into the surface; and evaporating the water to yield a treated surface having increased water resistance. The composition comprises a major amount of cement and a minor amount of a hydrophobic anion salt. The major amount of cement may be Portland cement, and the minor amount of hydrophobic anion salt may be potassium stearate, sodium stearate, as well as combinations thereof.

### BACKGROUND OF THE INVENTION

1. Field of the Invention

The present invention is directed to water resistant building materials and, more specifically, to compositions useful for increasing water resistance of concrete, masonry, and wood building materials, as well as to methods relating thereto.

2. Description of the Related Art

There are many materials in need of protection from moisture, particularly those materials that are exposed to an outside environment such as various building materials. For example, conventional building materials such as concrete blocks, bricks, and lumber are often exposed to ambient precipitation in the form of rain or snow. Such precipitation may not only weaken the physical integrity of the building material, but may also cause unwanted staining and discoloration. Within this context, it is known that the physical integrity of exposed concrete or masonry building materials tends to degrade over time because water may penetrate into these types of materials where it disrupts physical bonds associated with the underlying cementitious matrix. Similarly, the physical integrity of a wood building material may also tend to degrade over time because water may also penetrate into wood thereby allowing the formation of rot. In addition, water that has penetrated into concrete, masonry, or wood building materials is susceptible to freeze/thaw cycles that may further weaken the material's physical integrity. As a result of these shortcomings, there have been numerous “sealers” developed to increase the water resistance of concrete, masonry, and wood building materials. Exemplary in this regard are liquid sealers having one or more additives such as silanes, siloxanes, silicones, hydrocarbons, quaternary ammonium salts, waxes, fats, oils, acrylics, elastomerics, and rubberized compounds. In general, the function of these types of additives is to form a water repellent barrier integrally associated with one or more surfaces of the building material.

A problem associated with these types of additives is that they are generally carried in an organic solvent medium (e.g., a volatile organic compound (VOC)), many of which are believed to harmful to the environment and are thus strictly regulated.

Accordingly, there is a need in the art for compositions that are useful for sealing concrete, masonry, and wood building materials, as well as for methods relating thereto. The present invention fulfills these needs, and provides for further related advantages.

### BRIEF SUMMARY OF THE INVENTION

In brief, the present invention is directed to a method for increasing water resistance of a surface associated with a concrete, masonry or wood building material. The method comprises the steps of applying a selected amount of an aqueous treating solution to the surface, wherein the aqueous treating solution includes a hydrophobic anion salt dissolved in water; allowing a portion of the aqueous treating solution to absorb into the surface; and evaporating the water to yield a treated surface having increased water resistance. As disclosed herein, the term “hydrophobic anion salt” refers to a salt wherein the anion of that salt is generally water insoluble. A hydrophobic anion salt in this context would likely be polar and would generally have a “fat soluble” (water insoluble) end and a “water soluble” (fat insoluble) end.

As disclosed herein, the hydrophobic anion salt may be potassium stearate, sodium stearate, as well as combinations thereof. In the case of potassium stearate, the potassium stearate preferably ranges from about 0.01% to about 90.0% by weight of the aqueous treating solution, more preferably from about 0.01% to about 10.0% by weight of the aqueous treating solution, and even more preferably from about 0.01% to about 5.0% by weight of the aqueous treating solution.

In another aspect, the present invention is directed to a concrete, masonry or wood building material having a treated surface, wherein the treated surface is formed by the above-described method.

In yet another aspect, the present invention is directed to a composition useful for forming a concrete or cementitious building material. The composition comprises a major amount of a cementitious material and a minor amount of a hydrophobic anion salt. The major amount of the cementitious material may be Portland cement, and the minor amount of hydrophobic anion salt may be potassium stearate, sodium stearate, as well as combinations thereof. These and other aspects of the present invention will be evident upon reference to the following detailed description.

### DETAILED DESCRIPTION OF THE INVENTION

As noted above, the present invention is directed to water resistant building materials and, more specifically, to compositions useful for increasing water resistance of concrete, masonry, and wood building materials, as well as to methods relating thereto. Although many specific details of certain aspects of the present invention are set forth in the following detailed description, those skilled in the art will recognize that the present invention may have additional features, or that the invention may be practiced without several of the details disclosed herein.

In one aspect, the present invention is directed to a method for increasing water resistance of a surface associated with a concrete, masonry or wood building material. As used within the context of the present invention, the phrase “water resistance” refers to the ability to resist or repel water. Additionally, the phrase “concrete and masonry building material” is inclusive of cement and other mineral building material products including but not limited to any of the following: concrete, clay masonry, masonry, Portland cement (including normal Portland cement, modified Portland cement, high-early-strength Portland cement, low-heat Portland cement, sulfate-resisting Portland cement, air-entrained Portland cements, Portland blast-furnace slag cements, white Portland cement, Portland-pozzolana cement), redi-mix concrete, precast concrete, architectural concrete, concrete paving, pre-stressed concrete and masonry based on Portland cement, brick (including adobe, clay, reinforced clay, clay tile and clay pavers), stone (including granite, limestone and river rock), concrete block (including architectural building block, prefaced or glazed block, common building block and concrete products), mortar (such as lime mortar and lime-and-Portland cement mortar), hydraulic cement, alumina cement, synthetic calcium aluminate cement, expanded concrete, concrete block, slump block, concrete pavers, concrete roofing tiles, precast concrete, poured-in-place concrete, tilt-up concrete, ready-mixed concrete, architectural concrete, structural concrete, brick and other fired clay-based products such as ceramic, tile and terra-cotta, glass fiber reinforced concrete, exposed aggregate, grout, plaster, stucco, joint cement and natural cement, as well as other like cementitious materials. Finally, the phrase “wood building material” is inclusive all grades of lumber and other wood products (irrespective of whether or not the building material has a coating applied thereon).

More specifically, the method comprises the steps of applying a selected amount of an aqueous treating solution to the surface, wherein the aqueous treating solution includes a hydrophobic anion salt dissolved in water; allowing a portion of the aqueous treating solution to absorb into the surface; and evaporating the water to yield a treated surface having increased water resistance. For example, an aqueous treating solution (as disclosed in greater detail below) may be applied directly to the surface of a building material that is in need of moisture protection. The treating solution may then be allowed to soak into the surface layer of the building material. The residual water associated with the aqueous treating solution may then be evaporated (optionally through the use of a drying apparatus). By use of this method, it has been surprisingly discovered that the surface is sealed.

As noted above, the aqueous treating solution includes a hydrophobic anion salt dissolved in water. More specifically, the hydrophobic anion salt may be potassium stearate, sodium stearate, as well as various combinations thereof. Alternatively, the hydrophobic anion salt may be potassium stearate, sodium stearate, lithium stearate, potassium myristate, or sodium myristate, as well as various combinations thereof. In the case of potassium stearate, the potassium stearate preferably ranges from about 0.01% to about 90.0% by weight of the aqueous treating solution, more preferably from about 0.01% to about 10.0% by weight of the aqueous treating solution, and even more preferably from about 0.01% to about 5.0% by weight of the aqueous treating solution.

As is appreciated by those skilled in the art, the hydrophobic anion salts of the present invention are generally available from commercial suppliers (e.g., Springfield Scientific, Inc., Springfield, Oreg.). Alternatively, however, the hydrophobic anion salts of the present invention may be formed by reacting an alkali metal base and a carboxylic acid. For example, potassium stearate may be formed by reacting equal molar masses of stearic acid and potassium hydroxide within an aqueous medium.

More specifically, the following ratio of stearic acid and potassium hydroxide may be used (wherein the numbers given represent one molar mass of each constituent): stearic acid 284.50, and; potassium hydroxide 56.11. In order to form a reaction product of one mole of potassium stearate, 56.11 grams of potassium hydroxide may be dissolved into 659.39 grams of water followed by the addition of 284.50 grams of stearic acid. As is appreciated by those skilled in the art, heat and mechanical agitation may be needed to facilitate the reaction.

The reaction between stearic acid and potassium hydroxide should result in one mole of potassium stearate in a one molar solution. Potassium stearate has a molar mass of 322.58. A mole of stearic acid is 284.50 grams plus a mole of potassium hydroxide is 56.11 grams yielding a sum of 340.61 grams. The difference in the 340.61 sum of potassium hydroxide plus stearic acid and the 340.61 molar mass of 322.58 is 18.03 grams, which is accounted for by the loss of a water molecule in the reaction. Although potassium stearate may be commercially available, the many hydrophobic anion salts that are referred to herein, may not be readily available; therefore, such hydrophobic anion salts may be formed in a similarly manner as that described above for the making of potassium stearate.

In another aspect, the present invention is also directed to a concrete, masonry or wood building material having a treated surface, wherein the treated surface is formed by the above-described method. That is, the invention also covers various concrete, masonry, and wood building materials that have had the above described treating solution applied thereto (so as to result in increased water resistance of the underlying building material).

In yet another aspect, the present invention is further directed to a composition useful for forming a concrete or cementitious building material. The composition comprises a major amount of a cementitious mix material and a minor amount of a hydrophobic anion salt. (As used herein, the term “major” and “minor” are merely used to denote that in the total composition and on a weight basis, the amount of cementitious mix material is greater than the amount of hydrophobic anion salt, wherein the cementitious mix material is inclusive of all other ingredients besides the hydrophobic anion salt component.) The major amount of cementitious material may be Portland cement; however, the cementitious material is not so limited and may be any type of inorganic binder. The minor amount of hydrophobic anion salt may be potassium stearate, sodium stearate, as well as various combinations thereof Alternatively, the hydrophobic anion salt may be potassium stearate, sodium stearate, lithium stearate, potassium myristate, or sodium myristate, as well as various combinations thereof.

In short, it has been surprisingly discovered that a composition having a major amount of a cementitious material and a minor amount of a hydrophobic anion salt may be subsequently hydrated and then hardened to form a cement or concrete building product that has enhanced water resistant characteristics.

The compositions of the present invention may further include additional components. Hydrophobics and/or agents that form hydrophobics may also be added to enhance the sealing ability of the present invention. Perfumes and or colors may also be added to aid in the esthetic and olfactory value of the present invention. Biocides may be added to thwart biotic growth and extend product shelf-life.

As a final note, it is generally understood within the scope of the invention that hydrophobic anion salts respond to acidic environments with the formation of a hydrophobic carboxylic acid, and that hydrophobic anion salts within many basic environments form hydrophobic end products. The net effect is such that hydrophobic anion salts tend to react with either acidic or basic environments to produce hydrophobic end products. The utility of these characteristics is such that hydrophobic anion salts may yield hydrophobicity in many other potential uses both as coatings and as integral additives for materials that may be either basic or acidic. A further understanding within the scope of the invention regards hydrophobic anion salts with an alkali metal cation. Regardless of pH, when the alkali metal cation hydrophobic anion salt contacts cations such as calcium, magnesium, and aluminum, the resultant reaction forms hydrophobic products that are useful both as coatings and integral additives within a broad variety of materials.

For purposes of illustration and not limitation, the following examples more specifically disclose various aspects of the present invention.

### EXAMPLES

### Example 1

### Results of an Acid Base Reaction that Produced a Hydrophobic Anion Salt Useful in Sealing

First, 5.3 grams of potassium hydroxide were dissolved in 268.3 grams of water. Next, 26.4 grams of stearic acid was added to the aqueous potassium hydroxide solution and stirred for about twenty minutes while in a vessel within a vessel of boiling water, effectively a double boiler apparatus. The mixture resulted in an acid-base reaction between the stearic acid and the potassium hydroxide such that a 10% solution of potassium stearate was formed. Although the sum of the reactants was 31.7 grams and the potassium stearate product was 30 grams, the difference can be accounted for due to the loss of water in the acid-base reaction.

The 10% potassium stearate solution was then diluted to a 2% solution for use in sealing a concrete sidewalk. A portion of the concrete sidewalk was briefly rinsed with water from a hose and followed by application of the 2% potassium stearate solution with a scrub brush. The sidewalk portion was scrubbed for about 30 seconds and then rinsed with water from a hose.

Upon drying, the sidewalk exhibited surprising water repellency. To test the effectiveness of the sealing aspect, a small puddle of water consisting of 11 drops from an eye dropper was placed on the sealed area of the concrete sidewalk. Water droplets were placed on untreated areas of the concrete sidewalk as a control. Ambient weather conditions were about 60 degrees Fahrenheit, overcast, and no precipitation. After about four hours, the small puddle finally evaporated, apparently with little or no penetration into the sidewalk. Control areas tested with water droplets were quickly darkened as the water quickly penetrated the concrete sidewalk. After a few minutes the water droplets had penetrated the control areas so completely that it could not be discerned visually where those water droplets had originally been placed.

### Example 2

### Results of Sealing a Concrete Paver with a Hydrophobic Anion Salt

A new, clean, dry concrete paver was treated with a 1% aqueous solution of potassium stearate and allowed to cure and dry. After the water from the aqueous potassium stearate had dried, the paver was tested for evidence that the potassium stearate had provided utility as a sealer. A few drops of water were placed on the treated area individually and in small puddles consisting of from about 2 to about 20 drops of water. Water droplets were placed on untreated areas of the paver as a control. Treated areas exhibited extensive water repellency and kept the water from intruding for many hours until that water seemingly evaporated without having penetrated the paver.

Control areas tested with water droplets were quickly darkened as the water quickly penetrated the paver. After a few minutes the control areas had so completely engulfed the water that it could not be discerned visually where those water droplets had originally been placed.

### Example 3

### Results of Sealing Wood with a Hydrophobic Anion Salt

A section of green, non kiln dried hemlock measuring about 2.5 inches×4 inches×¼ inches was treated with a 1% solution of potassium stearate and allowed to dry. Another section was left untreated as a control. When the aqueous carrier of the solution had evaporated, the treated and untreated control surfaces were tested for water repellency. A single drop of water was placed, one each, on the treated and untreated control surfaces of the wood. After a few seconds the droplet on the untreated control area quickly spread out over the untreated control surface of the wood, while the droplet on the potassium stearate portion maintained a round shape that was elevated in the center above the surface of the treated area of the wood. The water droplet on the treated portion resisted penetration for about an hour while the water droplet on the control portion quickly penetrated the wood and became visually indiscernible within about fifteen minutes.

### Example 4

### Results of Sealing Mortar with a Hydrophobic Anion Salt used as an Integral Sealer Additive

A sample of a commercially available anhydrous mortar mix was selected for use in testing the utility a hydrophobic anion salt as an integral sealer additive. The anhydrous mortar mix consisted essentially of Portland cement and sand. The hydrophobic anion salt used in the test was 1% potassium stearate in an aqueous medium. 100 grams of the anhydrous mortar mix was contacted with 20.5 grams of the 1% potassium stearate solution and mechanically blended until homogeneous. The hydrous mortar sample was allowed to cure and dry for a period of about 24 hours before hydrophobicity testing was initiated. Droplets of water were placed on the cured surface of the integrally treated mortar sample and observed. The water droplets formed tight, round, nearly spherical balls that retained their shape until they evaporated several hours later having penetrated little if

1. A method for increasing water resistance of a surface associated with a concrete, masonry or wood building material, comprising the steps of:
applying a selected amount of an aqueous treating solution to the surface, wherein the aqueous treating solution includes a hydrophobic anion salt dissolved in water;
allowing a portion of the aqueous treating solution to absorb into the surface; and
evaporating the water to yield a treated surface having increased water resistance.

2. The method of claim 1 wherein the hydrophobic anion salt is potassium stearate, sodium stearate, or a combination thereof.

3. The method of claim 1 wherein the hydrophobic anion salt is potassium stearate.

4. The method of claim 3 wherein the potassium stearate ranges from about 0.001% to about 90.0% by weight of the aqueous treating solution.

5. The method of claim 3 wherein the potassium stearate ranges from about 0.001% to about 10.0% by weight of the aqueous treating solution.

6. The method of claim 3 wherein the potassium stearate ranges from about 0.001% to about 5.0% by weight of the aqueous treating solution.

7. A concrete, masonry or wood building material having a treated surface, wherein the treated surface is formed by the process of claim 1.

8. A composition useful for forming a cementitious building material, the composition comprising a major amount of a cementitious mix material and a minor amount of a hydrophobic anion salt.

9. The composition of claim 8 wherein the hydrophobic anion salt ranges from about 0.001% to about 10.0% by weight of the composition.

10. The composition of claim 8 wherein the hydrophobic anion salt ranges from about 0.001% to about 5.0% by weight of the composition.

11. The composition of claim 10 wherein the major amount of the cementitious material is Portland cement.

12. The composition of claim 11 wherein the minor amount of the hydrophobic anion salt is potassium stearate, sodium stearate, or a combination thereof.

13. The composition of claim 11 wherein the minor amount of the hydrophobic anion salt is potassium stearate.
